(19) United States
(12) Patent Application Publication
(10) Pub. No.: US 2014/0263733 A1
(43) Pub. Date: Sep. 18, 2014

(54) Self-Regulating Irrigation Controller

(71) Applicant: Rodney M. Shields, Ukiah, CA (US)

(72) Inventor: Rodney M. Shields, Ukiah, CA (US)

(21) Appl. No.: 14/214,411

(22) Filed: Mar. 14, 2014

Related U.S. Application Data
(60) Provisional application No. 61/791,221, filed on Mar. 15, 2013.

(51) Int. Cl. A01G 25/16

(52) U.S. Cl. CPC A01G 25/16
USPC 239/201

(57) ABSTRACT

A self-regulating irrigation system utilizing a hydro-expansive material to regulate fluid flow. an irrigation control valve that includes (i) a sprinkler with a control valve, wherein said control valve comprises a control spring and a diaphragm located within the sprinkler head, (ii) a base extending down from said sprinkler head, and (iii) a hydro-expansive control membrane attached to the diaphragm and the base. The hydro-expansive control membrane is a length of hydro-expansive material that is short enough and strong enough to overcome the force of the control spring when the control membrane is dry, yet long enough that it will extend when wet so that the force of the control spring overcomes the force of the control membrane to close the diaphragm.

### BACKGROUND OF THE INVENTION

Plant growth is highly dependent on the amount of water the plant receives. Too much or too little water can lead to substantial decreases in plant growth. Most current irrigation and watering systems need manual calibration to optimize plant/crop growth and efficiency. For example, a popular modern method for irrigation is drip irrigation, which uses pre-calibrated drip rates to continually dispense water to the roots of plants. Traditional methods such as drip irrigation cannot account for irregular additional water sources and irregular rates of water absorption. This can make irrigation system efficiency dependent on outside factors such as rain water.

An irrigation controller is a device to operate automatic irrigation systems such as lawn sprinklers and drip irrigation systems. Many irrigation controllers are electronic, and allow the user to set the frequency of irrigation, the start time, and the duration of watering. Some controllers have additional features such as multiple programs to allow different watering frequencies for different types of plants, rain delay settings, input terminals for sensors such as rain and freeze sensors, soil moisture sensors, weather data, remote operation, etc.

Automatic irrigation controllers utilizing diaphragm valves are known. These irrigation controllers generally use either an electric or hydraulic means to open and close the diaphragm valve. Most newer systems employ electromechanical or electronic controllers.

Although sophisticated electronic controllers that allow irrigation schedules to be automatically adjusted according to the weather are known, these controllers tend to be relatively expensive, and often require electronic communication with external systems. For example, evapotranspiration controllers calculate expected evapotranspiration, using, e.g., either a simple weather sensor, a soil moisture sensor, or a communication device that receives a daily update from an external source. With approximately half of potable water in urban areas being used for irrigation, and many homeowners either not taking the time to regularly adjust the programming on their controllers or simply not knowing how, “smart controllers” are useful for water conservation.

Accordingly, there is a need for watering and irrigation systems that regulate flow according to the actual amount of moisture present in the irrigated environment, with minimal or no human monitoring, and without the need for expensive, complicated, and power-consuming electronic components.

### BRIEF SUMMARY OF INVENTION

The invention is an apparatus and method for self-regulated dispensation of water. At its core, this invention utilizes a hydroexpansive material to act as a feedback controller for an irrigation controller. The hydroexpansive material allows water to be dispensed when the hydroexpansive material is dry. As the hydroexpansive material becomes wet, it expands, causing the irrigation system to close off. In this manner, the irrigation system is controlled with minimal or no human interaction, and without the need for electronic controllers or other expensive components.

The membrane acts as the driving force for the invention by expanding in overly moist environments. This expansion forces the seal to close the aperture thus limiting the flow of water. In order to appropriately calibrate the irrigation system, an adjustment collar can be applied around the membrane. This collar takes the form of a dial which when turned increases the compressive tension on the membrane. This in turn reduces membrane expansion and increases the output of water.

### BRIEF DESCRIPTION OF DRAWINGS

FIG. 1. Spring Clip Locking Model shown in closed (FIG. 1A) and open (FIG. 1B) positions.

FIG. 2. Cam Locking Model.

FIG. 3. External view of a self-regulating irrigation controller.

FIG. 4. External view of a self-regulating irrigation controller set in ground.

FIG. 5. Cutaway view of a self-regulating irrigation controller set in ground with water causing expansion of control membrane.

FIG. 6. Cutaway view of a self-regulating irrigation controller with control valve closed after expansion of hydroexpansive membrane.

FIG. 7. Cutaway view of a self-regulating irrigation controller with control valve open after hydroexpansive membrane dries and contracts.

FIG. 8. View of irrigation controller showing base with openings.

FIG. 9. Depiction of control adjustment for different environments.

FIG. 10. Cutaway view of hydro-expansive tube embodiment.

FIG. 11. Outer view of hydro-expansive tube embodiment with pointed gasket.

### DETAILED DESCRIPTION OF THE INVENTION

The self-regulating irrigation system can have a large number or embodiments. However in all these possible embodiments the key innovative feature is the use of a material that is non-destructively deformed when wet. This material must expand or contract as it is saturated with water. The membrane can be made of any material which meets these specifications such as cellulose, polyester, polyurethane, or other polymers. In preferred embodiments of the invention, the material is hydro-expansive, and the hydro-expansive nature of the membrane acts as the primary mechanism to regulate fluid flow.

### Spring Clip Locking Embodiment

FIG. 1 shows a first embodiment of the invention utilizing a spring clip regulating mechanism. In this embodiment, the irrigation controller is a tube. The tube contains a water entry point [1]. This end of the tube may include a coupling mechanism to assist fastening of a water source, including barbs, a screw coupling, or a shark-bite type locking valve. Using a band or connector [2], the water entry point is joined to elastic tubing [3]. This tubing is flexible and can be mechanically deformed. Using another band or connector [2] the elastic tubing is joined to a long rigid tube [8]. Surrounding a portion of the long rigid tube is a sleeve [5] comprised of hydro-expansive material. Attached to the hydro-elastic sleeve [5] proximal to the elastic tubing [3] is a movable collar [6] which can slide along the long rigid tube [8]. Attached to the movable collar [6] is a spring clip [4]. A fixed collar [7] attached to the distal end of the hydro-elastic sleeve [5] relative to the water entry point [1] attaches the hydro-expansive sleeve to the tube [8] in a fixed manner.

In moist environments, the hydro-expansive sleeve [5] expands and lengthens. The expansion of the hydro-expansive sleeve [5] forces the movable collar [6] to slide along the tube [8] towards the inlet. The sliding of the collar increases the force on the spring clip [4]. The spring clip [4] in turn deforms the elastic tube [3]. This deformation, shown in FIG. 1A, reduces the flow of water. In dry environments the hydro-expansive sleeve [5] shrinks and contracts, pulling the movable collar [6] to pull back, removing force from the elastic tube [3] and allowing water to flow. This configuration is shown in FIG. 1B.

### Cam Locking Embodiment

A second embodiment of the irrigation control system uses a cam locking mechanism. This mechanism is outlined in FIG. 2. The control valve in this embodiment is an elastic tube [201]. Using a clip or fastener [203] the elastic tube [201] is joined to a hydro-expansive membrane [206]. The hydro-expansive membrane [206] is attached to a cam [205]. This attachment can take many forms including a rod, gears, string, cable, or the like. If the attachment is flexible (e.g., a cable), the irrigation control system will include a control spring [202] that applies force on the cam [205] in opposition to force applied by the hydro-expansive membrane [206]. The cam [205] is placed on a pivot [204] near the elastic tube [201]. The elastic tube [201] can be attached to a spout [207], sprinkler head, or similar watering apparatus.

In moist environments the hydro-expansive membrane [206] will expand. This expansion will rotate the cam [205] so that it deforms the elastic tubing [201]. This deformation will limit the flow of water. This is the situation shown in FIG. 3. When the environment is dry, the hydro-expansive membrane will shrink. This will rotate the cam so the elastic tubing is less deformed. The elastic tubing will regain a more cylindrical shape and allow water to more freely flow.

### Sprinkler Head Embodiment

Another preferred embodiment of the invention, shown in FIGS. 3-9, is an irrigation control valve that includes (i) a sprinkler [311] with a control valve, wherein said control valve comprises a control spring [320] and a diaphragm [315] located within the sprinkler head [311], (ii) a base [318] extending down from said sprinkler head [311], and (iii) a hydro-expansive control membrane [319] attached to the diaphragm [315] and the base [318]. The hydro-expansive control membrane [319] is a length of hydro-expansive material that is short enough and strong enough to overcome the force of the control spring when the control membrane is dry, yet long enough that it will extend when wet so that the force of the control spring overcomes the force of the control membrane to close the diaphragm.

The fluid flows through a sprinkler head [311]. The sprinkler head [311] contains a water entry point [312], an aperture [313], and a water outlet [314]. The hydro-expansive membrane exerts force on a diaphragm [315]. A control spring [320] applies force in opposition to the hydro-expansive membrane [319]. In FIGS. 3-6, the mechanical mechanism for transferring force is a spring loaded piston [316]. Other possible embodiments for the sealing mechanism will be discussed later. In moist environments the membrane will expand and force the seal to close the diaphragm's aperture thus restricting the flow of water. Similarly, in dry environment the membrane will shrink and open the diaphragms aperture. This will allow water to flow freely through the diaphragm.

An adjustment collar [317] can be applied around the hydro-expansive membrane. The purpose of the adjustment collar is to add compressive tension to the membrane and reduce its normal ability to expand. This increased resistance to membrane expansion will effectively calibrate the device to dispense water under different moisture levels. If there is more compressive tension on the membrane, the membrane will require greater moisture levels to expand and close the aperture.

To use the irrigation controller, the base is set into the soil being irrigated. At the beginning of an irrigation cycle, the control membrane will be dry. The dry control membrane will hold the control valve's diaphragm in an open position. As water is dispensed, the soil will become increasingly saturated with water. The base is constructed such that water in the soil permeates into the control membrane, triggering its hydro-expansive qualities. As the control membrane lengthens, its force is be overcome by the static force of a control spring that closes the diaphragm, thereby slowing or stopping irrigation.

In a related configuration, shown in FIGS. 10 and 11, water or other fluid enters the assembly through the tube 1 and then through the holes or perforations of 3 and then out through the gap between the sealing gasket 6 and the adjustable valve body 7. The gasket is attached to an outer tube comprised of a hydro-expansive material 4 that shrinks or contracts when dry and expands as it hydrates. A cap or cover 2 attaches and seals the hydro-expansive tube to the water supply tube of 1. An elastic waterproof coating or layer 5 isolates the hydro-expansive material from the fluid inside the assembly. The hydro-expansive material is exposed on the exterior where it can be in direct contact with soil or other growth media and the moisture that the soil contains. As the soil moisture level varies so does the moisture level change within the hydro-expansive material causing the hydro-expansive material to expand and contract. As the hydro-expansive material 3 and the attached elastic waterproof coating 4 expands and lengthens and contracts the gasket attached to the end of the outer tube moves along with it opening or closing the gap in between the gasket and the adjustable valve body, thus regulating fluid flow through the assembly. The valve body 7 can be removably attached to the perforated section of the water supply tube 1 via a threaded assembly, which allows the valve body to be rotated thus moving the valve body in or out to adjust the flow of fluid through the assembly to compensate for soil conditions or plant moisture requirements. The valve body 7 could have a tapered or pointed end as shown in FIG. 11 to make it easier for the user to push the assembly into the soil. The fluid flows 8 through the assembly.

Depending on the embodiment of this device, the water outlet can take several forms. Some of these forms may include a spout or sprinkler head. Similarly the water outlet point can be above ground as with typical sprinklers or below ground as in drip irrigation.

### Hydro-Expansive Materials

Hydro-expansive materials can include natural materials such as leather, cotton, cellulose, jute and other such organic fibers and materials that naturally expand when hydrated, single component materials and composite materials.

Composite materials such as a combination of a hydrophilic material like sodium bentonite, an elastic binder such as butyl rubber or a matrix of acrylate polymer. Composite hydro-expansive materials are frequently employed as water stops to seal penetrations through concrete structures and are commercially available through many different manufacturers. One such product is AKWASTOP™ a composite of polymerizate of methacrylate and fillers, manufactured by CETCO Building Materials Group, another is Thoroseal™, Manufactured by BASF Chemical company.

Single component hydro expansive materials include modified chloroprene rubber, as used in the product Hydrotite, a water stop material manufactured by Greenstreak Group, Inc.

1. An apparatus for self-regulated dispensation of water, comprising:
a sprinkler head having an input aperture, an output aperture, and an interior chamber containing a control valve;
wherein said control valve comprises a control spring and a diaphragm located within said sprinkler head between said input aperture and said output aperture, said control spring in contact with said diaphragm, said diaphragm capable of forming an essentially water-tight seal, and
a planting body, attached to said sprinkler head and extending substantially downward from said sprinkler head, said planting body comprised of a rigid material;
a control membrane comprised of a strip of hydro-expansive material, said control member attached to said diaphragm at a one end of said strip and attached to a point on the planting body distal from said diaphragm at the opposite end of said strip, said control membrane attached to said diaphragm such that it is capable of applying force in opposition to the control spring.

2. An irrigation control valve comprising:
a sprinkler head having an input aperture, an output aperture, and an interior chamber containing a control valve;
wherein said control valve comprises a control spring and a diaphragm located within said sprinkler head between said input aperture and said output aperture, said control spring in contact with said diaphragm, said diaphragm capable of forming an essentially water-tight seal, and
a planting body, attached to said sprinkler head and extending substantially downward from said sprinkler head, said planting body comprised of a rigid material;
a control membrane comprised of a strip of hydro-expansive material, said control member attached to said diaphragm at a one end of said strip and attached to a point on the planting body distal from said diaphragm at the opposite end of said strip, said control membrane attached to said diaphragm such that it is capable of applying force in opposition to the control spring.
